(19) United States
(12) Patent Application Publication
(10) Pub. No.: US 2010/0177807 A1
(43) Pub. Date: Jul. 15, 2010

(54) METHOD AND APPARATUS FOR RELAYING WIRELESS TRAFFIC IN A WIRELESS NETWORK

(75) Inventor: Jianzhong Zhang, Irving, TX (US)

Correspondence Address: Docket Clerk, P.O. Drawer 800889, Dallas, TX, 75380, US

(73) Assignee: Samsung Electronics Co., Ltd., Suwon-si (KR)

(21) Appl. No.: 12/639,478

(22) Filed: Dec. 16, 2009

Related U.S. Application Data
(60) Provisional application No. 61/204,693, filed on Jan. 9, 2009.

(51) Int. Cl. H04B 3/36

(52) U.S. Cl. 375/211

(57) ABSTRACT

A relay station to relay wireless traffic between a base station and mobile stations. The relay station receives incoming subframes of OFDM symbols and transmits outgoing subframes of OFDM symbols. The relay station comprises a timing offset controller configured to control the transmission of a first outgoing subframe with respect to reception of a first incoming subframe, such that the first outgoing subframe either leads or lags the reception of the first incoming subframe by a first time offset. The first time offset is equal to at least one OFDM symbol.

### CROSS-REFERENCE TO RELATED APPLICATION(S) AND CLAIM OF PRIORITY

The present application is related to U.S. Provisional Patent Application No. 61/204,693, filed Jan. 9, 2009, entitled “METHOD OF RELAY OPERATION IN WIRELESS COMMUNICATIONS SYSTEMS”. Provisional Patent Application No. 61/204,693 is assigned to the assignee of the present application and is hereby incorporated by reference into the present application as if fully set forth herein. The present application hereby claims priority under 35 U.S.C. §119(e) to U.S. Provisional Patent Application No. 61/204,693.

### TECHNICAL FIELD OF THE INVENTION

The present application relates generally to wireless communications systems and, more specifically, to a wireless network relay.

### BACKGROUND OF THE INVENTION

The 3GPP LTE (Long Term Evolution) standard is the last stage in the realization of true 4th generation (4G) of mobile telephone networks. Most major mobile carriers in the United States and several worldwide carriers have announced plans to convert their networks to LTE beginning in 2009. LTE is a set of enhancements to the Universal Mobile Telecommunications System (UMTS). Much of 3GPP Release 8 will focus on adopting 4G mobile communications technology, including an all-IP flat networking architecture.

The 3GPP LTE standard uses orthogonal frequency division multiplexing (OFDM) for the downlink (i.e., from the base station to the mobile station). Orthogonal frequency division multiplexing (OFDM) is a multi-carrier transmission technique that transmits on many orthogonal frequencies (or subcarriers). The orthogonal subcarriers are individually modulated and separated in frequency such that they do not interfere with one another. This provides high spectral efficiency and resistance to multipath effects.

In 3GPP LTE wireless networks, a base station is commonly referred to as “eNodeB” (or eNB) and a mobile station is commonly referred to as “user equipment” (UE). For the purposes of this disclosure, however, the term “base station” (or BS) will be used in place of eNodeB and the term “mobile station” (or MS) will be used in place of user equipment.

In order to improve the coverage provided by 3GPP LTE wireless networks, it is proposed that 3GPP LTE wireless networks support the use of wireless relay stations that relay traffic between a base station and a mobile station. In operation, a relay station (RS) receives information from the BS in the downlink and forwards the received information to the MS. The relay station also receives information in the uplink from the MS and forwards the received information to the BS in the uplink.

However, self-interference is a major technical problem in relay operation. Self-interference occurs when a relay station receives data from a base station while simultaneously transmitting to one or more mobile stations using the same time and frequency resources. The transmit antennas and the receive antennas of the relay station are close together and the outgoing signal transmitted to the mobile stations that is fed back to the receive antennas is much stronger than the incoming signal received from the base station. The self-interference problem is particularly harmful with respect to control channel signals, such as the synchronization (SYNC) channel, the primary broadcast channel (PBCH), or the like.

FIG. 3 is a signal timing diagram for a 3GPP LTE relay station according to an exemplary embodiment of the prior art. In FIG. 3, base station-to-relay station (BS-RS) frame 300 is received in relay station (RS) 140 at the same time that RS 140 transmits relay station-to-mobile station (RS-MS) frame 350 to one or more mobile stations. Dotted line 399 indicates the alignment in time between the start of BS-RS frame 300 and the start of RS-MS frame 350. As a result, reference signal subframe 301 in BS-RS frame 300 is synchronized with reference signal subframe 351 in RS-MS frame 350 and reference signal subframe 302 in BS-RS frame 300 is synchronized with reference signal subframe 352 in RS-MS frame 350. Similarly, user data subframe signal 303 in BS-RS frame 300 is synchronized with user data subframe 353 in RS-MS frame 350 and user data subframe 304 in BS-RS frame 300 is synchronized with user data subframe 354 in RS-MS frame 350. Since subframes 301-304 and subframes 351-354 use the same frequency resources (i.e., subcarriers), self-interference occurs.

Self-interference is created because the PBCH subframe (or SYNC or other subframe) transmitted by the relay station carries a different payload that the PBCH subframe received by the relay station from the base station. The relay station uses its own ID and other parameters on the outgoing PBCH subframe, while the received PBCH subframe uses the ID and other parameters associated with the base station.

Therefore, there is a need in the art for improved relay stations for use in a wireless network. In particular, there is a need for a relay station suitable for use in a 3GPP LTE wireless network that mitigates the self-interference problem in the primary broadcast channel (PBCH) and other control channels.

### SUMMARY OF THE INVENTION

To address the above-described deficiencies of the prior art, a relay station configured to relay wireless traffic between a base station of a wireless network and a plurality of mobile stations is provided. In an advantageous embodiment, the relay station comprises: 1) receive path circuitry configured to receive from the base station incoming subframes of OFDM symbols, the incoming subframes comprising a first incoming common control channel subframe; and 2) transmit path circuitry configured to transmit to the mobile stations outgoing subframes of OFDM symbols, the outgoing subframes comprising a first outgoing common control channel subframe. The relay station further comprises 3) a timing offset controller configured to control the transmission of the first outgoing common control channel subframe with respect to reception of the first incoming common control channel subframe, such that the first outgoing common control channel subframe is either: i) transmitted a first time offset prior to reception of the first incoming common control channel subframe; or ii) transmitted a first time offset after reception of the first incoming common control channel subframe,

In one embodiment, the first time offset is equal to at least one OFDM symbol. In another embodiment, the first time offset is equal to at least one subframe.

It is a further object of the present disclosure to provide a method of mitigating self-interference for use in a relay station configured to relay wireless traffic between a base station of a wireless network and a plurality of mobile stations. The method comprises the steps of: i) receiving from the base station incoming subframes of OFDM symbols, the incoming subframes comprising a first incoming common control channel subframe; 2) transmitting to the mobile stations outgoing subframes of OFDM symbols, the outgoing subframes comprising a first outgoing common control channel subframe; and 3) introducing a first timing offset between transmission of the first outgoing common control channel subframe and reception of the first incoming common control channel subframe, such that the first outgoing common control channel subframe is one of: i) transmitted prior to reception of the first incoming common control channel subframe by the first time offset; and ii) transmitted after reception of the first incoming common control channel subframe by the first time offset.

In one embodiment of the method, the first time offset is equal to at least one OFDM symbol. In another embodiment of the method, the first time offset is equal to at least one subframe.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an exemplary wireless network that is suitable for operating a relay station according to one embodiment of the present disclosure;

FIG. 1B illustrates wireless transmissions in the uplink and downlink between a base station and a mobile station via a relay station according to one embodiment of the present disclosure;

FIGS. 2A and 2B illustrates an exemplary relay station in greater detail according to one embodiment of the present disclosure;

FIG. 3 is a signal timing diagram for a 3GPP LTE relay station according to an exemplary embodiment of the prior art;

FIG. 4 is a signal timing diagram for a 3GPP LTE relay station according to a first exemplary embodiment of the present disclosure;

FIG. 5 is a signal timing diagram for a 3GPP LTE relay station according to a second exemplary embodiment of the present disclosure; and

FIG. 6 is a signal timing diagram for a 3GPP LTE relay station according to a third exemplary embodiment of the present disclosure.

### DETAILED DESCRIPTION OF THE INVENTION

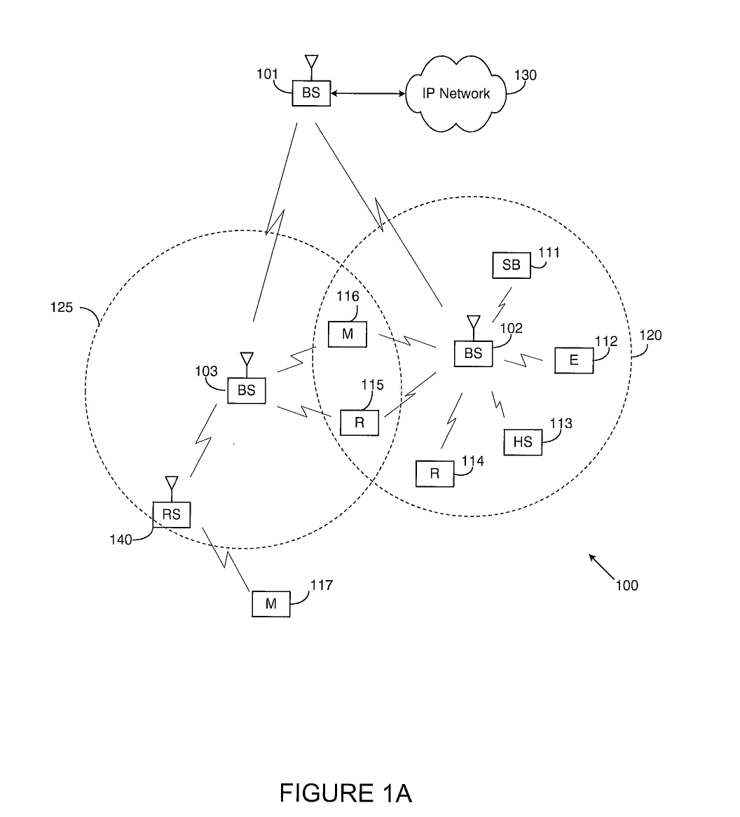

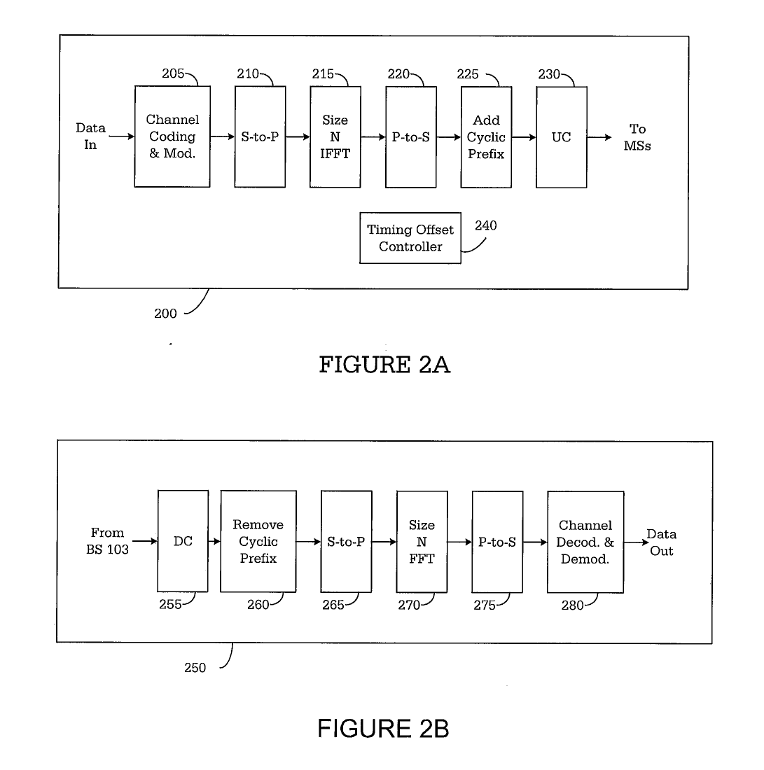

FIGS. 1 through 6, discussed herein, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

FIG. 1 illustrates exemplary wireless network 100 that is suitable for operating a relay station according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Depending on the network type, other well-known terms may be used instead of “base station,” such as “eNodeB” or “access point”. For the sake of convenience, the term “base station” shall be used herein to refer to the network infrastructure components that provide wireless access to remote terminals.

Base station 102 provides wireless broadband access to network 130, via base station 101, to a first plurality of mobile stations within coverage area 120 of base station 102. The first plurality of mobile stations includes mobile station (MS) 111, mobile station (MS) 112, mobile station (MS) 113, mobile station (MS) 114, mobile station (MS) 115 and mobile station (MS) 116. In an exemplary embodiment, MS 111 may be located in a small business (SB), MS 112 may be located in an enterprise (E), MS 113 may be located in a WiFi hotspot (HS), MS 114 may be located in a first residence (R), MS 115 may be located in a second residence, and MS 116 may be a mobile (M) device.

For sake of convenience, the term “mobile station” is used herein to designate any remote wireless equipment that wirelessly accesses a base station, whether or not the mobile station is a truly mobile device (e.g., cell phone) or is normally considered a stationary device (e.g., desktop personal computer, vending machine, etc.). Other well-known terms may be used instead of “mobile station”, such as “subscriber station (SS)”, “remote terminal (RT)”, “wireless terminal (WT)”, “user equipment (UE)”, and the like.

Base station 103 provides wireless broadband access to IP network 130, via base station 101, to a second plurality of mobile stations within coverage area 125 of base station 103. The second plurality of mobile stations includes mobile station 115 and mobile station 116. As will be explained below in greater detail, BS 103 also communicates indirectly with mobile station 117 via relay station (RS) 117. In alternate embodiments, base stations 102 and 103 may be connected directly to IP network 130 by means of a wireline broadband connection, such as an optical fiber, DSL, cable or T1/E1 line, rather than indirectly through base station 101.

In other embodiments, base station 101 may be in communication with either fewer or more base stations. It is noted that mobile station 115 and mobile station 116 are on the edge of both coverage area 120 and coverage area 125. Mobile station 115 and mobile station 116 each communicate with both base station 102 and base station 103 and may be said to be operating in handoff mode, as known to those of skill in the art.

In an exemplary embodiment, base stations 101-103 may communicate with each other and with mobile stations 111-116 in at least the downlink using orthogonal frequency division multiplexing (OFDM) protocol, according to the proposed 3GPP LTE standard, or an equivalent advanced 3G or 4G standard.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the mobile stations, weather conditions, and other factors. In an embodiment, the radius of the coverage areas of the base stations, for example, coverage areas 120 and 125 of base stations 102 and 103 may extend in the range from less than 2 kilometers to about fifty kilometers from the base stations.

As is well known in the art, a base station may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

In a preferred embodiment, the coverage area of at least base station 103 is enhanced by means of relay station (RS) 140, which operates according to the principles of the present disclosure. FIG. 1B illustrates wireless transmissions in the uplink and downlink between base station 103 and mobile station 117 via relay station 140 according to one embodiment of the present disclosure. RS 140 provides mobile station (MS) 117 and other mobile stations (not shown) with wireless access to BS 103. RS 140 receives frames of downlink traffic from BS 103 and retransmits the received frames of downlink traffic at increased power to MS 117. RS 140 also receives frames of uplink traffic from MS 117 and retransmits the received frames of uplink traffic at increased power to BS 103.

In order to mitigate the self-interference problem described above, in one embodiment of the current invention, relay station (RS) 140 introduces a relative timing offset between incoming frames of downlink traffic received from BS 103 and outgoing frames of downlink traffic transmitted to MS 117. The timing offset occurs at the subframe level within a frame. For example, a one (1) subframe timing offset (e.g., 1 millisecond) may be used to ensure, for example, that a PBCH subframe or another common control transmission subframe of BS 103 and RS 140 do not collide in the same subframe time slot, thereby mitigating self-interference.

In another embodiment of the current invention, the timing offset occurs at the OFDM symbol level within a subframe. This timing offset (measured in number of OFDM symbols) can be combined with the earlier mentioned timing offset (measured in number of subframes). As will be explained below in greater detail, the subframes and/or OFDM symbols transmitted from the relay station may be offset either to lead or to lag the subframes and/or OFDM symbols received from the base station.

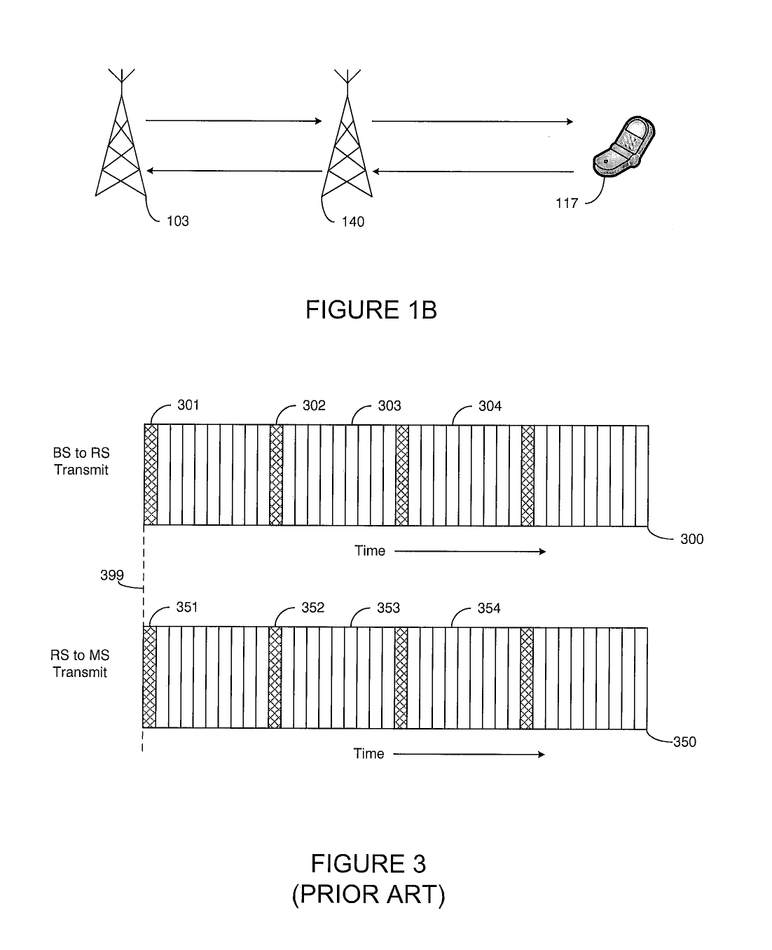

FIGS. 2A and 2B are high-level diagrams of exemplary relay station 140 according to one embodiment of present disclosure. RS 140 comprises transmit path circuitry 200 and receive path circuitry 250. Transmit path circuitry 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230, and timing offset controller 240. Receive path circuitry 250 comprises down-converter (DC) 255, remove cyclic prefix block 260, serial-to-parallel (S-to-P) block 265, Size N Fast Fourier Transform (FFT) block 270, parallel-to-serial (P-to-S) block 275, and channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

In transmit path circuitry 200, channel coding and modulation block 205 receives a set of information bits and modulates the input bits to produce a sequence of frequency-domain modulation symbols. The information bits include, among other things, a relay station identifier (RD ID) and other parameters associated with RS 140. The information bits also include reference control signals (e.g., pilot symbols and the like) that are to be transmitted to mobile stations, as well as data traffic previously received from base station 103.

Serial-to-parallel block 210 converts (i.e., de-multiplexes) the serial QAM symbols to parallel data to produce N parallel symbol streams where N is the IFFT/FFT size used in transmit path circuitry 200 and receive path circuitry 250. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal.

Finally, up-converter 230 modulates (i.e., up-converts) the output of add cyclic prefix block 225 to RF frequency for transmission via a wireless channel. The signal may also be filtered at baseband before conversion to RF frequency. In an exemplary embodiment, the time-domain output transmitted by transmit path circuitry 200 may be transmitted via multiple antennas to mobile stations within range of RS 140.

Receive path circuitry 250 receives incoming downlink signals transmitted by base stations 103. Down-converter 255 down-converts the received signal to baseband frequency and remove cyclic prefix block 260 removes the cyclic prefix to produce a serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and decodes the date symbols to recover the original data stream transmitted by BS 103.

The original date stream is eventually transferred to transmit path circuitry 200 to be re-transmitted to mobile station 117 and other mobile stations. According to the principles of the present disclosure, timing offset controller 240 controls the time offset between frames and subframes received from BS 103 and frames and subframes that are transmitted to MS 117 in order to mitigate self-interference.

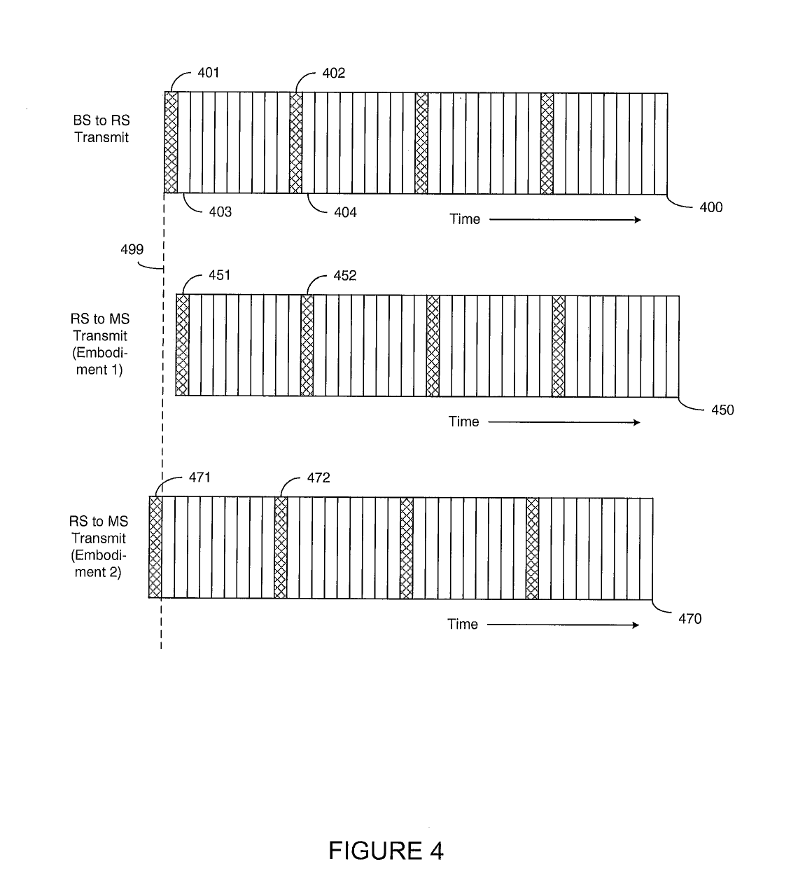

FIG. 4 is a signal timing diagram for 3GPP LTE relay station 140 according to a first exemplary embodiment of the present disclosure. In FIG. 4, timing offset controller 240 introduces a timing offset at the subframe level. In FIG. 4, timing offset controller 240 introduces one (1) subframe timing offsets that either lead or lag the signal received from BS 103. With a one subframe timing offset, the PBCH and other common control transmissions (e.g., SYNC channel) of BS 103 and RS 140 no longer collide in the same subframe, thereby mitigating self-interference. It is noted that the selection of a one subframe timing offset is by means of illustration only. Leading or lagging timing offsets of greater than one subframe may also be introduced.

RS 140 receives frame 400 in the downlink from BS 103. RS 140 transmits either frame 450 or frame 470 to MS 117, depending on whether timing offset controller 240 introduces a timing offset that leads or lags received frame 400. Dotted line 499 indicates the relative time offsets with respect to receive frame 400. In Embodiment 1, timing offset controller 240 introduces a lagging one subframe offset. In Embodiment 2, timing offset controller 240 introduces a leading one subframe offset.

Frame 400 comprises, among others, subframes 401-404. Exemplary subframes 401 and 402 (shaded) may comprise, for example, primary broadcast channel (PBCH) subframes or synchronization (SYNC) channel subframes. Exemplary subframes 403 and 403 may comprise, for example, user data subframes. Subframe 403 sequentially follows subframe 401 and subframe 404 follows subframe 402.

Frame 450 comprises, among others, subframes 451 and 452, which correspond to subframes 401 and 402, respectively. Thus, subframes 451 and 452 (shaded) comprise, for example, primary broadcast channel (PBCH) subframes or synchronization (SYNC) channel subframes. However, due to the lagging one subframe offset, the transmission of subframe 451 is synchronized with the reception of subframe 403 and the transmission of subframe 452 is synchronized with the reception of subframe 404.

Frame 470 comprises, among others, subframes 471 and 472, which correspond to subframes 401 and 402, respectively. Thus, subframes 471 and 472 (shaded) comprise, for example, primary broadcast channel (PBCH) subframes or synchronization (SYNC) channel subframes. However, due to the leading one subframe offset, the transmission of subframe 471 precedes the reception of subframe 401 and the transmission of subframe 472 precedes the reception of subframe 402.

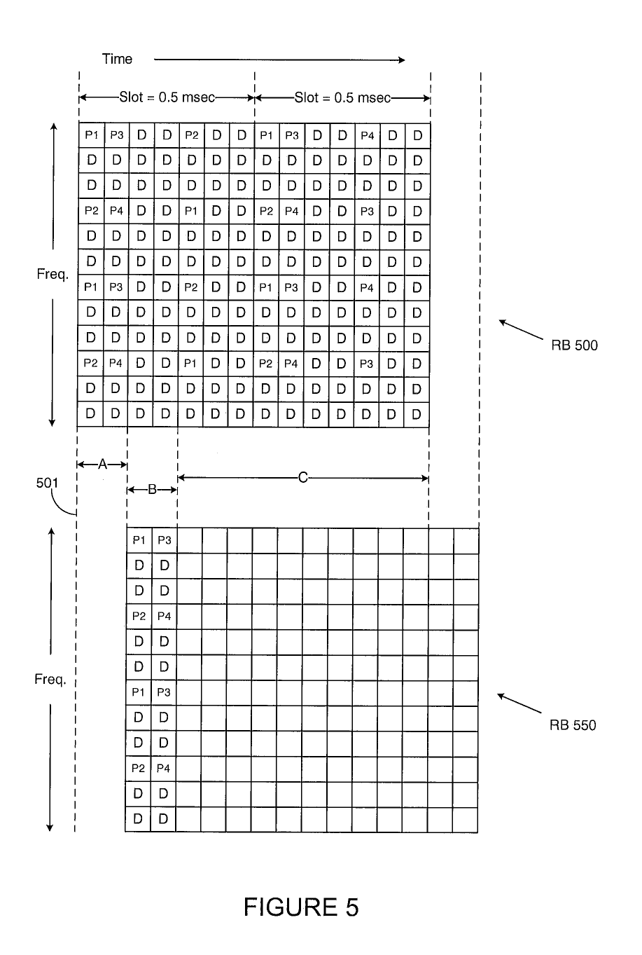

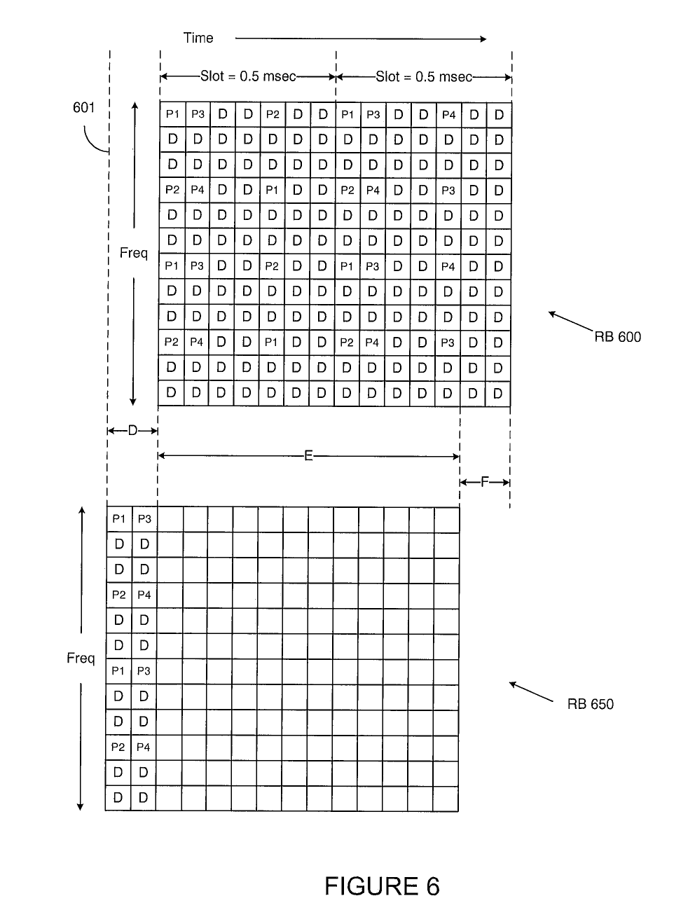

In another embodiment, timing offset controller 240 introduces a timing offset at the OFDM symbol level. This timing offset (measured in number of OFDM symbols) can be combined with the timing offset technique (measured in number of subframes) explained above in FIG. 4. In FIGS. 5 and 6 below, timing offset controller 240 introduces an exemplary two (2) OFDM symbol timing offset either to lead or to lag the OFDM symbols received from the base station 103.

FIG. 5 is a signal timing diagram for 3GPP LTE relay station 140 according to a second exemplary embodiment of the present disclosure. The top part of the timing diagram illustrates resource block (RB) 500, which is transmitted by BS 103 and received by RS 140. The bottom part of the timing diagram illustrates resource block (RB) 550, which is transmitted by BS 140. RB 500 and RB 550 may be a part of a subframe in which the PBCH or SYNC channel information is being transmitted. The horizontal axis indicates time. The vertical axis indicates frequency.

In FIG. 5, each OFDM symbol is aligned vertically. The squares in each vertical column represent different subcarrier frequencies that are part of the same OFDM symbol. The squares in each horizontal row represent the same subcarrier frequency in different OFDM symbols. Thus, each square represents a time-frequency resource element (RE) that may be individually modulated to transmit information.

Each OFDM symbol comprises N sequential subcarriers, where N may be, for example, 512, 1024, 2048, and so forth. As noted, each subcarrier may be individually modulated. For practical reasons, only a small segment of each OFDM symbol may be shown in RB 500. RB 500 spans an exemplary one (1) millisecond subframe, where each subframe comprises two (2) slots, each equal to 0.5 milliseconds in duration. The subframe contains 14 sequential OFDM symbols, so that each slot contains 7 sequential OFDM symbols. However, this is by way of example only and should not be construed to limit the scope of the present disclosure. In alternate embodiments, the slots may be greater than or less than 0.5 milliseconds in duration and a subframe may contain more than or less than 14 OFDM symbols.

In the exemplary embodiment, RB 500 spans 12 sequential subcarriers in the frequency dimension and 14 OFDM symbols in the time dimension. Thus, RB 500 contains 168 time-frequency resources. Again, however, this is by of example only. In alternate embodiments, RB 500 may span more than or less than 12 subcarriers and more than or less than 14 OFDM symbols, so that the total number of resource elements (REs) in RB 500 may vary. In a multi-antenna system, such as a multiple-input, multiple-output (MIMO) base station, the subcarriers labeled P1, P2, P3 and P4 represent reference signals (e.g., pilot signals) that are transmitted from antenna ports P1, P2, P3, and P4. The subcarriers labeled D represent data signals that are transmitted to one or more mobile stations via RB 500.

RB 550 is similar in most respects to RB 500 and need not be explained in great detail. In the example, RB 550 also comprises 168 time-frequency resources (shown as squares) that are transmitted as part of 14 OFDM symbols spanning one subframe (or two times slots). The reference signals and data transmitted via RB 550 are not necessarily related to the reference signals and data transmitted via RB 500. It is noted that the first one or two OFDM symbols in RB 550 are typically part of the RS 140 resource map that controls mobile station in communication with RS 140 and the first one to three OFMD symbols in RB 500 are part of the BS 103 resource map that controls either RS 140 or a mobile stations in communication with BS 103. In order to reduce self-interference, RB 550 is offset in time (either leading or lagging) from RB 500 by one or more OFDM symbols.

Dotted line 499 indicates the relative timing offset of RB 500 and RB 550. In FIG. 5, RB 550 lags RB 500 by two OFDM symbols. The time periods, A, B and C, are shown. During Period A, relay station 140 receives the first two OFDM symbols in RB 500 from BS 103. During Period B, RS 140 ignores any transmission by BS 103 and transmits the first 2 OFDM symbols of RB 140, which are aligned in time with the third and fourth OFDM symbols of RB 500. Finally, during Period B, relay station 140 receives the last ten OFDM symbols in RB 500 from BS 103.

Thus, relay station 140 sends the first two OFDM symbols without the need to listen to the transmission of BS 103 in the same two OFDM symbols. In one embodiment, during these two OFDM symbols, BS 103 may not consider the time-frequency resources elements in these two OFDM symbols in the rate-matching and data-to-physical resource mapping process. Therefore, no transmission occurs from BS 103 during these two OFDM symbols. In an alternative embodiment, BS 103 may continue transmission within these two OFDM symbols, but relay station 140 will simply ignore ignores transmission from BS 103 during these two OFDM symbols.

In addition to the example shown in FIG. 5, where RS 140 starts subframe transmission one or several OFDM symbols after BS 103 (i.e., lags), in an alternate embodiment, RS 140 may begin transmission of a subframe one or several OFDM symbols earlier than BS 103 (i.e., leads). FIG. 6 is a signal timing diagram for 3GPP LTE relay station 140 according to a third exemplary embodiment of the present disclosure.

In the embodiment shown in FIG. 6, RS 140 leads BS 103 by an exemplary two (2) OFDM symbols, as indicated by dotted line 601. FIG. 6 is similar in most respects to FIG. 5 and need not be explained in great detail. Resource block (RB) 600 is transmitted by BS 103 and received by RS 140. Resource block (RB) 650 is transmitted by RS 140. During Period D, RS 140 transmits the first 2 OFDM symbols in RB 650. During Period E, BS 140 listens while BS 103 transmits the first twelve OFDM symbols of RB 600. In Period F, the last 2 OFDM symbols of RB 600 are ignored by RS 140 and therefore contain no data. Since the last 2 OFDM symbols are empty, RB 600 may be truncated. This simplifies data puncture and rate matching in BS 103 compared to the situation in FIG. 5, where the third and fourth OFDM symbols in RB 500 may contain no data.

RS 140 uses control signaling to indicate to BS 103 the size of the time offset and whether or not it is a leading time offset or a lagging time offset. In advantageous embodiments of the present disclosure, BS 103 takes into account the time offset implemented by relay station 140 in the encoding chain for the physical downlink shared channel (PDSCH) region in RB 500. In FIG. 5, BS 103 does not transmit data in the two OFDM symbols during Period B, so that only the OFDM symbols in Period C are available to carry data. Similarly, in FIG. 6, BS 103 does not transmit data in the two OFDM symbols during Period F, so that only the OFDM symbols in Period E are available to carry data.

In both situations, the number of OFDM symbols available to carry data is reduced, so that BS 103 uses a reduced PDSCH region to transmit data. The size of the reduction corresponds to the number of OFDM symbols in the time offset. As a result, BS 103 modifies the rate matching, code block segmentation, data-to-resource mapping, and the like, in the encoding chain to support the reduced PDSCH region. Since the PDSCH region from BS 103 is reduced in size, RS 140 likewise modifies its own decoding chain to compensate for the reduced PDSCH region.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A relay station configured to relay wireless traffic between a base station of a wireless network and a plurality of mobile stations, the relay station comprising:
receive path circuitry configured to receive from the base station incoming subframes of OFDM symbols, the incoming subframes comprising a first incoming common control channel subframe;
transmit path circuitry configured to transmit to the mobile stations outgoing subframes of OFDM symbols, the outgoing subframes comprising a first outgoing common control channel subframe; and
a timing offset controller configured to control the transmission of the first outgoing common control channel subframe with respect to reception of the first incoming common control channel subframe, such that the first outgoing common control channel subframe is one of:
transmitted a first time offset prior to reception of the first incoming common control channel subframe; and
transmitted a first time offset after reception of the first incoming common control channel subframe,
wherein the first time offset is equal to at least one subframe.

2. The relay station as set forth in claim 1, wherein the first outgoing common control channel subframe is associated with a primary broadcast channel (PBCH) signal.

3. The relay station as set forth in claim 1, wherein the first outgoing common control channel subframe is associated with a synchronization channel (SYNC) signal.

4. The relay station as set forth in claim 1, wherein the timing offset controller is further configured to control the transmission of the first outgoing common control channel subframe with respect to reception of the first incoming common control channel subframe by introducing a second time offset in addition to the first time offset, wherein the second time offset has a duration of at least one OFDM symbol.

5. The relay station as set forth in claim 4, wherein the second time offset is one of: i) a leading time offset, and ii) a lagging time offset.

6. A relay station configured to relay wireless traffic between a base station of a wireless network and a plurality of mobile stations, the relay station comprising:
receive path circuitry configured to receive from the base station incoming subframes of OFDM symbols, the incoming subframes comprising a first incoming common control channel subframe;
transmit path circuitry configured to transmit to the mobile stations outgoing subframes of OFDM symbols, the outgoing subframes comprising a first outgoing common control channel subframe; and
a timing offset controller configured to control the transmission of the first outgoing common control channel subframe with respect to reception of the first incoming common control channel subframe, such that the first outgoing common control channel subframe is one of:
transmitted a first time offset prior to reception of the first incoming common control channel subframe; and
transmitted a first time offset after reception of the first incoming common control channel subframe,
wherein the first time offset is equal to at least one OFDM symbol.

7. The relay station as set forth in claim 6, wherein the base station transmits a reduced PDSCH region to the relay station, the size of the reduction in the reduced PDSCH region corresponding to the number of OFDM symbols in the first time offset, and wherein the base station modifies at least one of the rate matching, code block segmentation, and data-to-resource mapping in the base station to support the reduced PDSCH region.

8. The relay station as set forth in claim 6, wherein the relay station modifies a decoding chain in the receive path circuitry to support the reduced PDSCH region.

9. For use in a relay station configured to relay wireless traffic between a base station of a wireless network and a plurality of mobile stations, a method of mitigating self-interference comprising the steps of:
receiving from the base station incoming subframes of OFDM symbols, the incoming subframes comprising a first incoming common control channel subframe;
transmitting to the mobile stations outgoing subframes of OFDM symbols, the outgoing subframes comprising a first outgoing common control channel subframe; and
introducing a first timing offset between transmission of the first outgoing common control channel subframe and reception of the first incoming common control channel subframe, such that the first outgoing common control channel subframe is one of:
transmitted prior to reception of the first incoming common control channel subframe by the first time offset; and
transmitted after reception of the first incoming common control channel subframe by the first time offset,
wherein the first time offset is equal to at least one subframe.

10. The method as set forth in claim 9, wherein the first outgoing common control channel subframe is associated with a primary broadcast channel (PBCH) signal.

11. The method as set forth in claim 9, wherein the first outgoing common control channel subframe is associated with a synchronization channel (SYNC) signal.

12. The method as set forth in claim 9, further comprising the step of:
introducing a second time offset in addition to the first time offset, wherein the second time offset has a duration of at least one OFDM symbol.

13. The method as set forth in claim 12, wherein the second time offset is one of: i) a leading time offset, and ii) a lagging time offset.

14. For use in a relay station configured to relay wireless traffic between a base station of a wireless network and a plurality of mobile stations, a method of mitigating self-interference comprising the steps of:
receiving from the base station incoming subframes of OFDM symbols, the incoming subframes comprising a first incoming common control channel subframe;
transmitting to the mobile stations outgoing subframes of OFDM symbols, the outgoing subframes comprising a first outgoing common control channel subframe; and
introducing a first timing offset between transmission of the first outgoing common control channel subframe and reception of the first incoming common control channel subframe, such that the first outgoing common control channel subframe is one of:
transmitted prior to reception of the first incoming common control channel subframe by the first time offset; and
transmitted after reception of the first incoming common control channel subframe by the first time offset,
wherein the first time offset is equal to at least one OFDM symbol.

15. The method as set forth in claim 14, wherein the first outgoing common control channel subframe is associated with a primary broadcast channel (PBCH) signal.

16. The method as set forth in claim 14, wherein the first outgoing common control channel subframe is associated with a synchronization channel (SYNC) signal.

17. A wireless network comprising:
a plurality of base stations configured to communicate with a plurality of mobile stations; and
a relay station configured to relay wireless traffic between a a first base station and at least one of the plurality of mobile stations, the relay station comprising:
receive path circuitry configured to receive from the first base station incoming subframes of OFDM symbols, the incoming subframes comprising a first incoming common control channel subframe;
transmit path circuitry configured to transmit to the at least one mobile station outgoing subframes of OFDM symbols, the outgoing subframes comprising a first outgoing common control channel subframe; and
a timing offset controller configured to control the transmission of the first outgoing common control channel subframe with respect to reception of the first incoming common control channel subframe, such that the first outgoing common control channel subframe is one of:
transmitted a first time offset prior to reception of the first incoming common control channel subframe; and
transmitted a first time offset after reception of the first incoming common control channel subframe,
wherein the first time offset is equal to at least one OFDM symbol.

18. The wireless network as set forth in claim 17, wherein the first outgoing common control channel subframe is associated with a primary broadcast channel (PBCH) signal.

19. The wireless network as set forth in claim 17, wherein the first outgoing common control channel subframe is associated with a synchronization channel (SYNC) signal.

20. The wireless network as set forth in claim 17, wherein the first time offset is equal to at least one subframe.

21. A base station configured to communicate with a plurality of mobile stations via a relay station, the base station determining a time offset value used by the relay station to advance or delay transmissions of subframes to the plurality of mobile stations, wherein the base station, in response to the time offset value, transmits a reduced PDSCH region to the relay station, the size of the reduction in the reduced PDSCH region corresponding to the size of the time offset value.

22. The base station as set forth in claim 21, wherein the base station modifies at least one of the rate matching, code block segmentation, and data-to-resource mapping in the base station to support the reduced PDSCH region.

23. For use in a base station configured to communicate with a plurality of mobile stations via a relay station, a method to transmitting data to the relay station comprising the steps of:
determining in the base station a time offset value, wherein the relay station uses the time offset to advance or delay transmissions of subframes to the plurality of mobile stations; and
in response to the time offset value, transmitting a reduced PDSCH region from the base station to the relay station, the size of the reduction in the reduced PDSCH region corresponding to the size of the time offset value.

24. The method as set forth in claim 23, further comprising the step of:
modifying in the base station at least one of the rate matching, code block segmentation, and data-to-resource mapping performed by the base station to support the reduced PDSCH region.
